(19) United States
(12) Patent Application Publication
(10) Pub. No.: US 2011/0317419 A1
(43) Pub. Date: Dec. 29, 2011

(54) Roadside lamp with a heat dissipating design

(76) Inventor: Huan-Chang HUANG, Guishan Township (TW)

(21) Appl. No.: 12/825,443

(22) Filed: Jun. 29, 2010

(51) Int. Cl. F21S 4/00

(52) U.S. Cl. 362/249.02; 362/249.01

(57) ABSTRACT

A roadside lamp with a heat dissipating design is disclosed. The roadside lamp of the present invention comprises a seat portion and a plurality of light emitting units. A panel is fitted to the seat portion and the light emitting units are fitted to the panel. The back portion of the panel is tightly fitted to a heat dissipating fin-like portion. A pair of rails extends outwardly from the fin-like portion. The pair of rails may be used to connect the roadside lamp with a surface in a place such as a tunnel. For example, a track may be provided on the top portion of a tunnel; therefore, a plurality of the roadside lamps may be fitted to the track in a tidy manner. The pair of rails allows each roadside lamp to be fitted to the track and thus, the location of the lamp may be adjusted.

### BACKGROUND OF THE INVENTION

1. Field of the Invention

The invention generally relates to a roadside lamp with a heat dissipating design. More particularly, the invention relates to a roadside lamp that allows production to be simplified, costs to be lowered, and may be used for many places and applications.

2. Description of the Prior Art

With regard to the improvements made for the roadside lamp in the prior art, the majority of them focused on the level of brightness of the light emitted from the lamp. Therefore, ease of installation and maintenance was not taken into consideration and excessive labor and time were unnecessarily wasted or spent.

There have been roadside lamps with artistic design on the market. Though they have improved in regards to appearance, their production cost is relatively high and their maintenance is not easily performed. In addition, when the roadside lamps are installed, a worker must bring the components of each lamp to a higher elevation; therefore, the installation is difficult to implement and the worker's safety is jeopardized during the installation.

In the prior art, when a large number of roadside lamps are installed, they are installed individually and hence, such installation takes an excessive amount of time; in addition, it is difficult to have them installed in a tidy condition and this may result in additional re-installation cost and time.

Also, LEDs have gradually replaced the conventional lights because LEDs have the advantages of high level of brightness and longer service life. However, because LEDs generates a large amount of heat, heat must be dissipated effectively to ensure the longer service life of LEDs.

When LEDs are used for the illumination of roads, lighting efficiency and pollution coefficient have to be taken into consideration to ensure the service life of the LEDs.

From the above, we can see that the lamp of the prior art has many disadvantages and needs to be improved. To eliminate the disadvantages in the prior art, the inventor has put a great deal of effort into the subject and has successfully come up with the roadside lamp of the present invention.

### SUMMARY OF THE INVENTION

An object of the present invention is to provide a roadside lamp whose components are modules made separately to enable the roadside lamp of the present invention to be used for regular lampposts and in a tunnel. Therefore, the installation of the roadside lamp of the present invention is simplified and may be implemented swiftly and accurately.

Another object of the present invention is to provide a roadside lamp that prevents the need for a worker to stay in an elevated location for an extended period to install the lamps and thus improves the safety conditions for the worker.

A third object is to provide a roadside lamp that has a module design so as to simplify production, enhance output and lower cost.

To reach these objects, the roadside lamp of the present invention is disclosed. The roadside lamp of the present invention comprises a seat portion and a plurality of light emitting units. A panel is fitted to the seat portion and the light emitting units are fitted to the panel. The back portion of the panel is tightly fitted to a heat dissipating fin-like portion. A pair of rails extends outwardly from the fin-like portion. The pair of rails may be used to connect the roadside lamp with a surface in a place such as a tunnel. For example, a track may be provided on the top portion of a tunnel; therefore, a plurality of the roadside lamps may be fitted to the track in a tidy manner. The pair of rails allows each roadside lamp to be fitted to the track and then the location of the lamp may be adjusted. A sealing portion is disposed at either end of the seat portion to seal the two ends. A connective portion is provided on the inner side of each sealing portion and can connect with the edge of the fin-like portion to hold the latter in position. Several holes are provided in the fin-like portion and each sealing portion to facilitate the use of screws. The seat portion may be fitted to a regular lamppost to form a regular roadside lamp. A connective tube may be provided on the sealing portion to connect the seat portion to a regular lamppost.

### BRIEF DESCRIPTION OF THE DRAWINGS

The drawings disclose an illustrative embodiment of the present invention which serves to exemplify the various advantages and objects hereof, and are as follows:

FIG. 1 is an exploded view showing the roadside lamp of the present invention.

FIG. 2 is a perspective view showing the roadside lamp of the present invention in an assembled condition.

FIG. 3 is a perspective view showing how the light emitting units are fitted.

FIG. 4 is a perspective view showing another configuration in which the light emitting units are fitted.

FIG. 5 is a perspective view showing how the roadside lamp of the present invention is fitted to a track.

FIG. 6 is a perspective view showing how the roadside lamp of the present invention is fitted to a regular lamppost to form a regular roadside lamp.

FIG. 7 is a diagram showing L, H, R and a with regard to the international standard.

FIG. 8 is a diagram showing how the five light emitting units are configured in the present invention.

FIG. 9 is a perspective view showing a connective unit provided on the roadside lamp of the present invention.

FIG. 10 is a perspective view showing another example of a connective unit provided on the roadside lamp of the present invention.

List of reference numerals

| | |
|---|---|
| 1 Seat portion | 11 Panel |
| 12 Heat dissipating fin-like portion | 13 A pair of rails |
| 14 Sealing portion | 15 Connective portion |
| 16 and 17 Holes | 18 Connective tube |
| 2, 21, 22 and 23 Light emitting units | 3 Track |
| 4 Screws | 5 Power supply device |
| 6 Lamppost | 7 Connective unit |
| H Height of a lamp | α Angle of illumination |
| L Travel distance of light | R Radius of illumination |

### DETAILED DESCRIPTION OF THE PREFERRED EMBODIMENTS

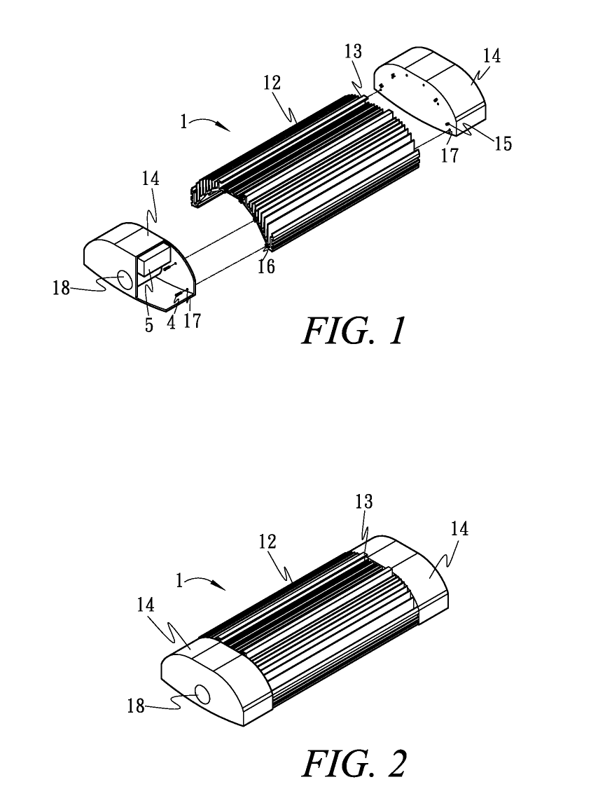

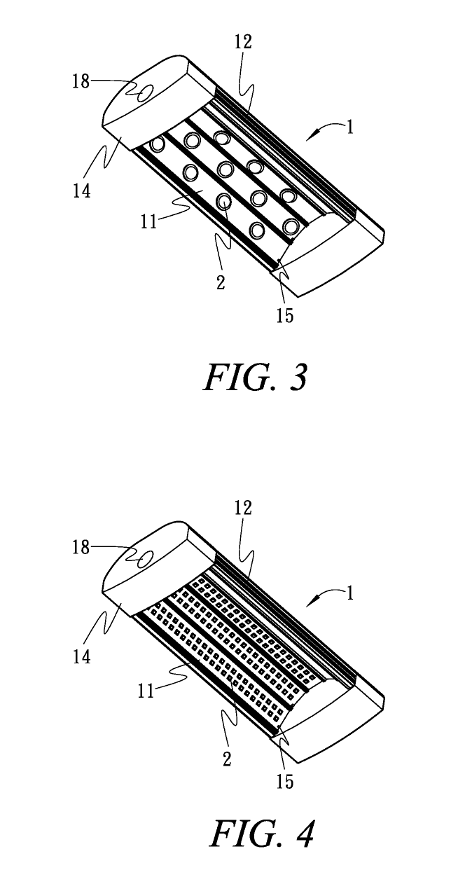

Please see FIGS. 1 to 4, which illustrate the roadside lamp of the present invention. The roadside lamp of the present invention comprises a seat portion 1 and a plurality of light emitting units 2. A panel 11 is fitted to the seat portion 1 and the light emitting units 2 are fitted to the panel 11. The light emitting units 2 may be any type of light emitting unit. In the present invention, LEDs with a high level of brightness are used to utilize the high level of brightness and long service life of such LEDs. In addition, the panel 11 is a module made separately according to the actual number of the LEDs so as to achieve easy production and easy maintenance of the roadside lamp of the present invention. In the present invention, LEDs are placed in a certain configuration by utilizing the fact that light travels in a straight line so as to meet the international standard.

The back portion of the panel 11 is tightly fitted to a heat dissipating fin-like portion 12. The bent design of the fin-like portion 12 enables it to dissipate heat effectively and to eliminate the accumulation of water and dusts. In addition, the fin-like portion 12 is made of aluminum alloy so as to dissipate heat quickly, reduce the size and weight of the roadside lamp, and ensure the reliability of the LEDs 2. Therefore, heat may be dissipated effectively, the lighting efficiency of the roadside lamp of the present invention may be enhanced and the roadside lamp of the present invention may have a longer service life.

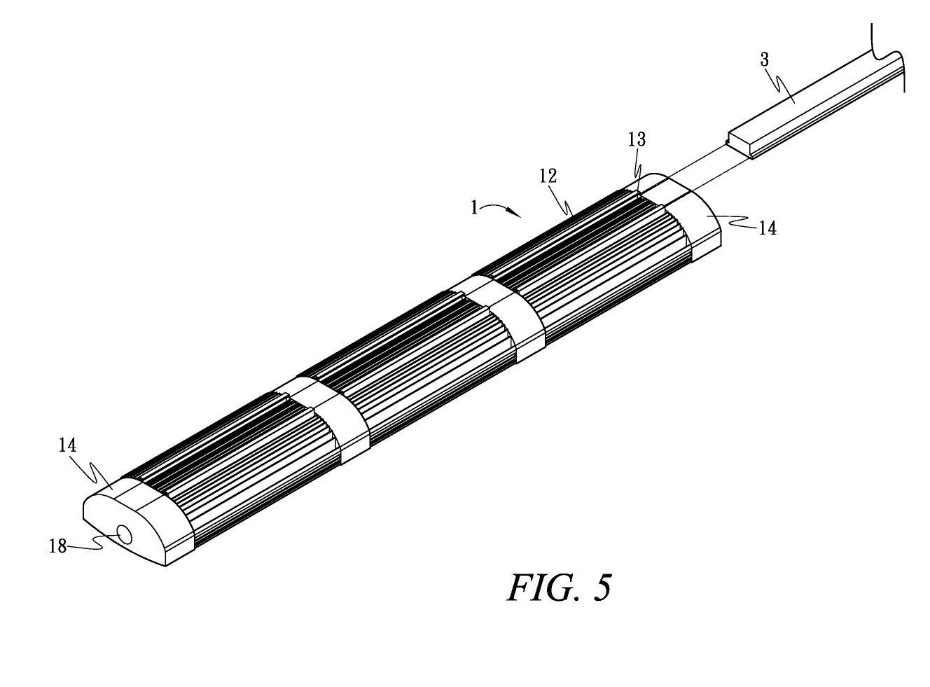

Please see FIG. 5. A pair of rails 13 extends outwardly from the fin-like portion 12. The pair of rails 13 may be used to connect the roadside lamp with a surface in a place such as a tunnel. For example, a track 3 may be provided on the top portion of a tunnel; therefore, a plurality of the roadside lamps may be fitted to the track in a tidy manner. The pair of rails 13 allows each seat portion 1 to be fitted to the track and allows the location of the lamp to be adjusted. Therefore, a plurality of the seat portions 1 may be fitted to the track 3 to achieve the best result of illumination.

Please refer to FIGS. 1 to 4. A sealing portion 14 is disposed at either end of the seat portion 1 to seal the two ends. If a plurality of the seat portions 1 are fitted to a track in a linear, continuous manner, only two sealing portions 14 are needed to seal the two ends.

The sealing portions 14 are formed separately. A connective portion 15 is provided on the inner side of each sealing portion 14 and can connect with the edge of the fin-like portion 12 to hold the latter in position. Several holes 16 and 17 are provided in the fin-like portion 12 and each sealing portion 14 to facilitate the use of screws 4. A power supply device 5 or a power source and a circuit is provided inside the sealing portion 14 to provide electricity, which should match the electric requirements of the light emitting units 2.

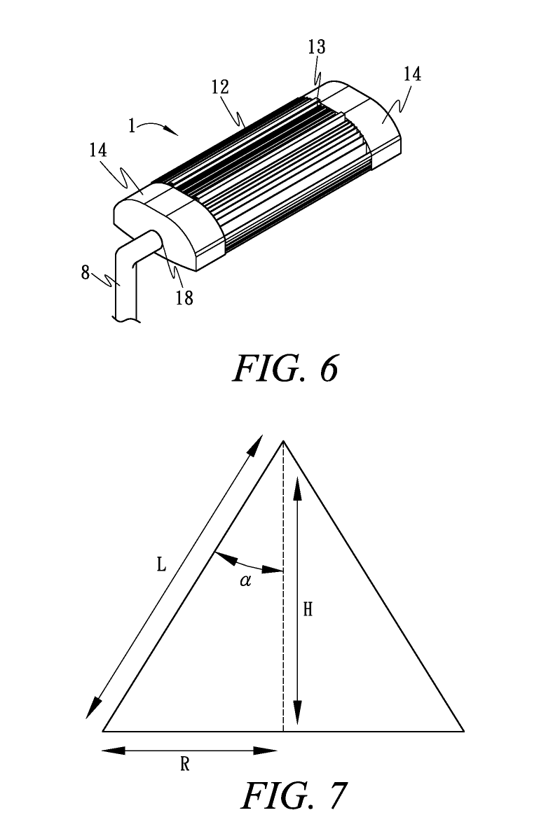

Please see FIG. 6. The seat portion 1 may be fitted to a regular lamppost to form a regular roadside lamp. A connective tube 18 may be provided on the sealing portion 14 to connect the seat portion 1 to a lamppost 6.

Please see FIG. 7. Table 1 illustrates the heights of roadside lamps in the international standard. In Table 1, H stands for the height of a lamp and α is the angle of illumination. From H and α, we can obtain L (travel distance of light), R (radius of illumination) and A (area of illumination).

TABLE 1
the international standard for H

| α (degree) | H (m) | R (m) | Diameter (m) | L (m) | A (m²) |
|---|---|---|---|---|---|
| 32.5 | 4 | 2.55 | 5.10 | 4.74 | 20.3903319 |
| 32.5 | 5 | 3.19 | 6.37 | 5.93 | 31.8598936 |
| 32.5 | 6 | 3.82 | 7.64 | 7.11 | 45.87824678 |
| 32.5 | 7 | 4.46 | 8.92 | 8.30 | 62.44539146 |
| 32.5 | 8 | 5.10 | 10.19 | 9.49 | 81.5613276 |
| 32.5 | 9 | 5.73 | 11.47 | 10.67 | 103.226055 |
| 32.5 | 10 | 6.37 | 12.74 | 11.86 | 127.439574 |
| 32.5 | 11 | 7.01 | 14.02 | 13.04 | 154.201885 |
| 32.5 | 12 | 7.64 | 15.29 | 14.23 | 183.5129871 |
| 55 | 4 | 5.71 | 11.43 | 6.97 | 102.4698421 |
| 55 | 5 | 7.14 | 14.28 | 8.72 | 160.1091282 |
| 55 | 6 | 8.57 | 17.14 | 10.46 | 230.5571447 |
| 55 | 7 | 10.00 | 19.99 | 12.20 | 313.8138913 |
| 55 | 8 | 11.43 | 22.85 | 13.95 | 409.879368 |
| 55 | 9 | 12.85 | 25.71 | 15.69 | 518.753575 |
| 55 | 10 | 14.28 | 28.56 | 17.43 | 640.436513 |
| 55 | 11 | 15.71 | 31.42 | 19.18 | 774.9281807 |
| 55 | 12 | 17.14 | 34.28 | 20.92 | 922.2285787 |

For regular roads, α is 32.5 degree and H is 8 to 10 m. For freeways, α is 55 degree and H is 8 to 10 m.

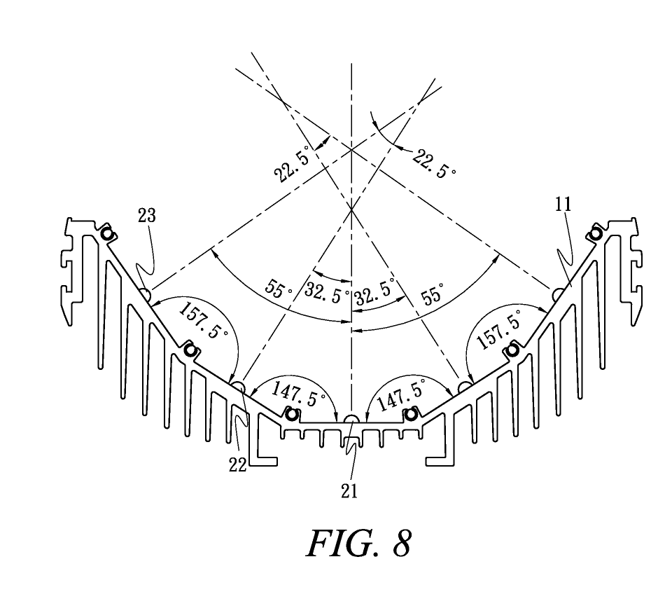

Please see FIG. 8. In the roadside lamp of the present invention, five light emitting units 2 are fitted to the panel 11 in a symmetric manner. A first light emitting unit 21 is centrally disposed. A second light emitting unit 22 is disposed on either side of the first light emitting unit 21 and the angle between them is 32.5 degrees. A third light emitting unit 23 is disposed by either of the two second light emitting units 22 and the angle between the former and the first light emitting unit 21 is 55 degrees. Therefore, such configuration meets the international standard. Also, α may vary within the range of ±5 degrees according to the actual condition.

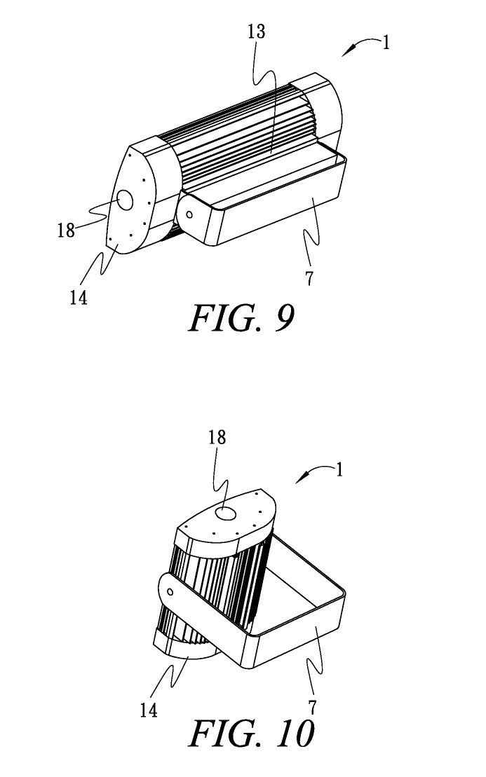

Please see FIGS. 9 and 10. A connective unit 7 may be provided on the pair of rails 13 or other location of the seat portion 1. The angle of the connective unit 7 may be adjusted longitudinally or transversely. Therefore, the connective unit 7 enables the roadside lamp to be used in places such as walls, storage rooms, etc.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A roadside lamp with a heat dissipating design, comprising:
a seat portion, wherein a panel is fitted to the seat portion and light emitting units are fitted to the panel, and wherein the back portion of the panel is tightly fitted to a heat dissipating fin-like portion and a pair of rails extends outwardly from the fin-like portion; and
a plurality of light emitting units,
characterized in that the pair of rails may be used to connect the seat portion with a track provided on the top portion of a tunnel.

2. The roadside lamp as in claim 1, wherein a sealing portion is disposed at either end of the seat portion to seal the two ends.

3. The roadside lamp as in claim 2, wherein a power supply device or a power source and a circuit is provided inside the sealing portion to provide electricity.

4. The roadside lamp as in claim 2, wherein a connective portion is provided on the inner side of each sealing portion and can connect with the edge of the fin-like portion to hold the latter in position, and wherein several holes are provided in the fin-like portion and each sealing portion to facilitate the use of screws.

5. The roadside lamp as in claim 2, wherein a connective tube may be provided on the sealing portion to connect the seat portion to a regular lamppost.

6. The roadside lamp as in claim 1, wherein the light emitting units may be LED's.

7. The roadside lamp as in claim 1, wherein the panel is a module made separately according to the actual number of the LED's so as to achieve easy manufacturing and easy maintenance of the roadside lamp of the present invention.

8. The roadside lamp as in claim 1, wherein a connective unit may be provided on the pair of rails or other location of the seat portion and the angle of the connective unit may be adjusted longitudinally or transversely.

9. The roadside lamp as in claim 1, wherein five light emitting units are fitted to the panel in a symmetric manner, and wherein a first light emitting unit is centrally disposed and a second light emitting unit is disposed on either side of the first light emitting unit and the angle between them is 32.5±5 degree, and wherein a third light emitting unit is disposed by either of the two second light emitting units and the angle between the former and the first light emitting unit is 55+5 degree.
